(19) United States
(12) Patent Application Publication
(10) Pub. No.: US 2018/0289004 A1
(43) Pub. Date: Oct. 11, 2018

(54) STABLE LIQUID VOLATILE PEROXY ACID AND ALCOHOL CONTAINING SPORICIDAL DISINFECTING COMPOSITION

(71) Applicant: ECOLAB USA INC., Saint Paul, MN (US)

(72) Inventors: Silke DENZIN, Langenfeld (DE); Katja TEUSCH, Dormagen (DE); Laurence GERET, Neuss (DE); Carola STINGL, Duesseldorf (DE)

(21) Appl. No.: 15/764,672

(22) PCT Filed: Sep. 29, 2015
(86) PCT No.: PCT/EP2015/072461

§ 371 Date: Mar. 29, 2018

(51) Int. Cl. A01N 37/16; A01N 37/02; A01N 31/02; A01N 59/00; A01N 25/02

(52) U.S. Cl. CPC A01N 37/16; A01N 37/02; A01N 25/02; A01N 59/00; A01N 31/02

(57) ABSTRACT

The present invention relates to a stable liquid, volatile peroxyacid containing sporicidal disinfecting composition, effective in deactivating, inhibiting, disabling, killing, and/or sterilizing bacterial spores, comprising: —about ≥0.05 wt.-% to about ≤10 wt.-% of at least one C₂ to C₈ carboxylic acid and at least one C₂ to C₈ peroxycarboxylic acid, —about ≥2 wt.-% to about ≤20 wt.-% of an peroxide agent, —about ≥20 wt.-% to about ≤50 wt.-% of an alcohol with about 2 to about 4 carbons, —the remainder to 100% by weight is water, based on the total weight of the sporicidal liquid composition.

### FIELD OF THE INVENTION

The invention relates to disinfection compositions that are volatile, highly effective against bacterial spores and stable as well as a method of manufacture thereof. The invention further relates to the use of such compositions for disinfection purposes in deactivating, inhibiting, disabling, killing, or otherwise sterilizing bacterial spores.

### BACKGROUND

Peroxycarboxylic acids are known for use as antimicrobial agents that can kill or otherwise inhibit the growth or proliferation of microbes including bacteria, bacterial spores, yeasts, viruses and fungi.

### BACKGROUND OF THE INVENTION

Peroxyacid compositions, namely peroxycarboxylic acid compositions, exhibit useful antimicrobial and bleaching activity. Conventional peroxycarboxylic acid compositions typically include short chain peroxycarboxylic acids or mixtures of short chain peroxycarboxylic acids and medium chain peroxycarboxylic acids. However, peroxyacid compositions have a number of limitations, including low volatility, stability concerns, malodor problems and insufficient micro efficacy against certain microorganisms.

For an efficient disinfection of surfaces, it would be desirable to have a highly volatile peroxyacid based composition, which as the same time is stable and efficient.

U.S. Pat. No. 4,051,058 Grosse Bowing describes stable peroxy containing concentrates comprising essentially of peracetic acid or peroxypropionic acid, hydrogen peroxide, water and a sequestering agent. This composition does not have a sufficient volatility. Furthermore, it suffers from unacceptable odors, which are an inherent disadvantage of the compositions and limit their use in cleaning applications. It would be undesirable to apply such a peroxycarboxylic acid composition to large surfaces areas, for example floor cleaners.

US Patent Application US 2013 00 18097, published as WO 2013/009754 A2, relates to compositions of peroxyacids, such as mixed peroxycarboxylic acid compositions, having improved antimicrobial efficacy compared to conventional peroxyacid compositions due in part to the solubilization of the mixed peroxyacid compositions using esters. This reference further relates to methods employing the enhanced microbial efficacy compositions at reduced temperatures, including for example, use in aseptic cleaning. In a particular aspect of this prior art, peroxyacid compositions include an alcohol or esters for the solubilization of the peroxyacids to generate compositions having a lower use concentration. Preferably, up to 5% to about 15% alcohol might be used.

There is a need for antimicrobial agents having good antimicrobial efficacy. Although many peroxyacid compositions have a broad spectrum of antimicrobial properties, many have inadequate activity against hard to kill pathogens, including bacterial spores, fungal spores, and fungi. As a result, killing, inactivating, or otherwise reducing the active population of bacterial spores and fungi on surfaces is particularly difficult. The bacterial spore-forming microorganisms of the Bacillus species are especially important to be aware of during food packaging, particularly during cold or hot aseptic filling of food and beverage, or pharmaceutical, products. Microorganisms of the Bacillus species include Bacillus atropheaus, Bacillus cereus, Bacillus mycoides, Bacillus subtilis, Bacillus anthracis, and Bacillus thuringiensis. These latter microorganisms share many phenotypical properties, have a high level of chromosomal sequence similarity, and are known enterotoxin producers. Bacillus cereus is one of the most problematic because Bacillus cereus has been identified as possessing increased resistance to germicidal chemicals used to decontaminate environmental surfaces. For example, Blakistone et al., Efficacy of Oxonia Active Against Selected Sporeformers, Journal of Food Protection, Volume 62, pages 262 267, report that Bacillus cereus was more tolerant to the effects of conventionally formulated peroxyacetic acid germicides than all other spore-forming bacteria tested, including other Bacillus and Clostridium species.

According to the invention, there is a need for improved highly volatile, low odor stable and efficient antimicrobial peroxycarboxylic acid compositions.

It is an objective of the claimed invention to develop improved peroxyacid chemistry as a volatile ready to use formulation.

A further object of the invention is an improved peroxyacid composition with enhanced microbial efficacy for targeting endospore-forming bacilli type bacteria.

A further object of the invention is a method of use for applications employing a lower use concentration of a peroxyacid composition having enhanced microbial efficacy.

A further object of the invention is to provide improved peroxyacid compositions and methods for using the compositions for clean in place (CIP) applications, for example cleaning of tanks, lines, pumps and other process equipment used for processing typically liquid product streams of beverages, in particular for cleaning milking machines.

A still further object of the invention is to provide improved peroxyacid compositions and methods for using the compositions for clean out of place (COP) applications, for example cleaning the interior and exterior surfaces of a wide variety of parts, such as ceramic surfaces, metal surfaces, walls in, wash tanks, soaking vessels, mop buckets, holding tanks, scrub sinks, vehicle parts washers, non-continuous batch washers and systems, and the like.

### BRIEF SUMMARY OF THE INVENTION

In one aspect, the disclosure provides a stable liquid, volatile peroxyacid containing sporicidal disinfecting composition comprising:
about ≥0.05 wt.-% to about ≤10 wt.-% of at least one C₂ to C₈ carboxylic acid and at least one C₂ to C₈ peroxycarboxylic acid,
about ≥2 wt.-% to about ≤20 wt.-% of an peroxide agent, preferably hydrogen peroxide,
about ≥20 wt.-% to about ≤50 wt.-% of an alcohol with about 2 to about 4 carbons,
the remainder to 100% by weight is water, based on the total weight of the sporicidal liquid composition.

In one aspect, the disclosure provides a stable liquid, volatile peroxyacid containing sporicidal disinfecting composition comprising:
about ≥0.05 wt.-% to about ≤10 wt.-% of at least one organic C₂ to C₈ peroxycarboxylic acid and at least one C₂ to C₈ carboxylic acid, preferably at least one peroxycarboxylic acid and one carboxylic acid are selected from the group comprising of peracetic acid, acetic acid, peroxypropionic acid, propionic acid, peroxyoctanoic acid, octanoic acid, mixtures of peracetic acid and acetic acid, mixtures of peroxypropionic acid and propionic acid, mixtures of octanoic acid and peroxyoctanoic and/or a mixture of peracetic acid, acetic acid, octanoic acid and peroxyoctanoic;
about ≥2 wt.-% to about ≤20 wt.-%, preferably about ≥4 wt.-% to about ≤15 wt.-% of hydrogen peroxide;
about >20 wt.-% to about ≤50 wt.-% of an alcohol with about 2 to about 4 carbons, wherein the alcohol is preferably selected from the group comprising ethanol, propanol-1 or propanol-2 or butanol-1 or a mixture of two or more of them, and n-propanol may be most preferred; and
the remainder to 100% by weight is water; wherein the weight-% is based on the total weight of the sporicidal liquid composition.

In one aspect, the disclosure provides a stable liquid, volatile peroxyacid containing sporicidal disinfecting composition comprising:
about ≥0.05 wt.-% to about ≤10 wt.-% of at least one organic C₂ to C₈ peroxycarboxylic acid and at least one C₂ to C₈ carboxylic acid, preferably at least one peroxycarboxylic acid and one carboxylic acid are selected from the group comprising of peracetic acid, acetic acid, peroxypropionic acid, propionic acid, peroxyoctanoic acid, octanoic acid, mixtures of peracetic acid and acetic acid, mixtures of peroxypropionic acid and propionic acid, mixtures of octanoic acid and peroxyoctanoic and/or a mixture of peracetic acid, acetic acid, octanoic acid and peroxyoctanoic, wherein the total amount peroxyacid is present in an amount of from ≥0.01 wt.-% to about ≤5 wt.-%, preferably ≥0.05 wt.-% to about ≤2 wt.-%, further preferred about ≥0.1 wt.-% to about ≤1 wt.-% and more preferred about ≥0.2 wt.-% to about ≤0.5 wt.-%;
about ≥4 wt.-% to about ≤15 wt.-% of hydrogen peroxide;
about >20 wt.-% to about ≤50 wt.-% of an alcohol with about 2 to about 4 carbons, wherein the alcohol is preferably selected from the group comprising ethanol, propanol-1 or propanol-2 or butanol-1 or a mixture of two or more of them, and n-propanol may be most preferred;
optional at least one surfactant and/or sequestering agent;
the remainder to 100% by weight is water; wherein the weight-% is based on the total weight of the sporicidal liquid composition.

In another aspect, the disclosure may provide an embodiment of a stable liquid, volatile peroxyacid containing sporicidal disinfecting composition, wherein
about ≥0.01 wt.-% to about ≤5 wt.-%, preferably ≥0.05 wt.-% to about ≤2 wt.-%, further preferred about ≥0.1 wt.-% to about ≤1 wt.-% and more preferred about ≥0.2 wt.-% to about ≤0.5 wt.-%, of at least one C₂ to C₃ peroxyacid or a mixture of a C₂ and C₈ peroxyacid and preferably peroxy acetic acid;
about ≥2 wt.-% to about ≤10 wt.-%, preferably about ≥2.5 wt.-% to about ≤5 wt.-% or about ≥3 wt.-% to about ≤4 wt.-% of at least one C₂ to C₃ organic acid or a mixture of a C₂ and C₈ organic acid, and preferably acetic acid;
about ≥4 wt.-% to about ≤15 wt.-% of hydrogen peroxide;
about >20 wt.-% to about ≤50 wt.-% of an alcohol with about 2 to about 4 carbons, wherein the alcohol is preferably selected from the group comprising ethanol, propanol-1 or propanol-2 or butanol-1 or a mixture of two or more of them, and n-propanol may be most preferred;
optional at least one surfactant and/or sequestering agent;
the remainder to 100% by weight is water; wherein the weight-% is based on the total weight of the sporicidal liquid composition.

In another aspect, the disclosure may provide an embodiment of a stable liquid, volatile peroxyacid containing sporicidal disinfecting composition comprising
about ≥0.01 wt.-% to about ≤5 wt.-%, preferably ≥0.05 wt.-% to about ≤2 wt.-%, further preferred about ≥0.1 wt.-% to about ≤1 wt.-% and more preferred about ≥0.2 wt.-% to about ≤0.5 wt.-%, of at least one C₂ to C₃ peroxyacid selected from the group comprising of peracetic acid and/or peroxypropionic acid, and preferably the peroxyacid is peracetic acid;
about ≥2 wt.-% to about ≤10 wt.-%, preferably about ≥2.5 wt.-% to about ≤5 wt.-% or about ≥3 wt.-% to about ≤4 wt.-% of a C₂ to C₃ acid selected from the group comprising of acetic acid and/or propionic acid, and preferably the acid is acetic acid;
about ≥2 wt.-% to about ≤15 wt.-%, preferably about ≥5 wt.-% to about ≤10 wt.-%, of hydrogen peroxide;
about ≥25 wt.-% to about ≤40 wt.-%, preferably ≥30 wt.-% to about ≤35 wt.-%, of at least one alcohol selected from the group comprising ethanol, propanol-1, propanol-2 or butanol-1 or a mixture of two or more of them, and more preferred n-propanol or iso-propanol, and most preferred n-propanol; and
optional at least one surfactant and/or sequestering agent;
the remainder to 100% by weight is water; wherein the weight-% is based on the total weight of the of the sporicidal liquid composition.

In another aspect, the disclosure may provide an embodiment of a sporicidal liquid composition comprising:
about ≥0.05 wt.-% to about ≤1 wt.-%, preferably about ≥0.1 wt.-% to about ≤1 wt.-% or about ≥0.2 wt.-% to about ≤0.5 wt.-% of a C₂ to C₃ peroxyacid selected from the group comprising of peracetic acid and/or peroxypropionic acid, and preferably the peroxyacid is peracetic acid,
about ≥2 wt.-% to about ≤10 wt.-%, preferably about ≥2.5 wt.-% to about ≤5 wt.-% or about ≥3 wt.-% to about ≤4 wt.-% of a C₂ to C₃ acid selected from the group comprising of acetic acid and/or propionic acid, and preferably the acid is acetic acid,
about ≥2 wt.-% to about ≤15 wt.-% of hydrogen peroxide,
about ≥25 wt.-% to about ≤35 wt.-% of n-propanol or iso-propanol,
optional at least one surfactant and/or sequestering agent;
the remainder to 100% by weight is water; wherein the weight-% is based on the total weight of the sporicidal liquid composition.

In another aspect, the disclosure provides an embodiment of a sporicidal liquid composition comprising:
about ≥5 wt.-% to about ≤15 wt.-% hydrogen peroxide;
≥1 wt.-% to about ≤4 wt.-% acetic acid;
>25 wt.-% to about ≤35 wt.-%, of at least one n-propanol or iso-propanol, and most preferred n-propanol;
optional at least one surfactant and/or sequestering agent;
the remainder to 100% by weight is water; wherein the weight-% is based on the total weight of the sporicidal liquid composition.

In another aspect, the disclosure provides an embodiment of a sporicidal liquid composition comprising:
about ≥2 wt.-% to about ≤20 wt.-%, preferably about ≥5 wt.-% to about ≤15 wt.-%, hydrogen peroxide;
about ≥0.05 wt.-% to about ≤10 wt.-%, preferably about ≥1 wt.-% to about ≤5 wt.-%, more preferred about ≥2 wt.-% to about ≤4 wt.-%, of at least one organic C₂ to C₈ carboxylic acid, preferably acetic acid and/or propionic acid and most preferred acetic acid;
≥20 wt.-% to about ≤50 wt.-%, preferably >25 wt.-% to about ≤35 wt.-%, of at least one C₂ to C₄ alcohol, preferably at least one C₂ to C₃ alcohol and more preferred n-propanol or iso-propanol, and most preferred n-propanol;
optional at least one surfactant and/or sequestering agent;
the remainder to 100% by weight is water; wherein the weight-% is based on the total weight of the sporicidal liquid composition.

In another aspect, the disclosure provides the use of the stable liquid, volatile peroxyacid containing sporicidal disinfecting composition for deactivating, inhibiting, disabling, killing and/or sterilizing spores.

Other aspects and embodiments are encompassed by the disclosure and will become apparent in light of the following description.

### DETAILED DESCRIPTION

The disclosure provides a liquid composition that combines several advantages. At first, it is volatile. That means that it evaporates within a short time when applied to a surface. Short time means that 2.5 ml to 5.0 ml of the composition according to the invention placed on the upper surface of a horizontal positioned glass plate of about 10 cm×about 10 cm at a temperature of about 23° C. and an air humidity of about 40% evaporates within a time period of about ≥2 minutes to about ≤4 minutes. Nevertheless, it is highly efficient and has a long shelf live.

In more details, it is highly effective in deactivating, inhibiting, disabling, killing and/or sterilizing spores. The sporicidal liquid composition is ready-to-use. Such compositions may be useful for deactivating, inhibiting, disabling, killing and/or sterilizing spores on surfaces of articles used in healthcare, food and beverage industry and any other place, where the reduction of microbial burden is desirable.

It has been surprisingly found that the sporicidal liquid composition maybe highly effective in deactivating, inhibiting, disabling, killing and/or sterilizing bacterial spores, although it dries very easily, when applied to a surface. In addition the sporicidal liquid composition may be less corrosive, less skin irritating and/or low foaming. Thus, the sporicidal liquid composition may feature high sporicidal activity at short contact times, being less metal corrosive and provides significant malodor reduction. The sporicidal liquid compositions according to the invention provide a shelf life of at least 6 months at storage conditions at about 25° C. and a sporicidal efficacy against Bacillus subtilis according to EN 13704.

So that the invention maybe more readily understood, certain terms are defined.

As used herein, “by weight” refers to the total weight of the composition. For example, if a composition has a total weight of 100 grams and comprises 40% (by weight) of an alcohol, the composition comprises 40 grams of alcohol.

It is understood that the total weight percent amount of all components, substances or agents of a composition are selected such that it does not exceed 100 wt.-%.

As used herein, the term “add. water to 100 wt.-%” and “the remainder to 100% by weight is water” are synonymous used.

As used herein, the abbreviation “add.” means added.

It is understood that, as used here, “percent”, “%”, and the like are intended to be synonymous with “weight percent”, “wt-%”, etc.

The term “disinfection,” when used in the context of a sporicidal liquid agent or sporicidal liquid composition, refers to an agent or composition that can kill or otherwise inhibit the growth or proliferation of microbes including, for example, bacteria, viruses, fungi and bacterial spores.

As used herein in the context of a sporicidal liquid agent or sporicidal liquid composition, the term “microorganism” refers to any non-cellular or unicellular (including colonial) organism, including all prokaryotes, bacteria (including cyanobacteria), spores, lichens, fungi, protozoa, virinos, viroids, viruses, phages, and algae.

Similarly, the term “sporicidal activity” as used in the context of a sporicidal liquid agent or sporicidal liquid composition refers to activity that can kill or otherwise inhibit the growth or proliferation of microbes including bacteria, yeasts, viruses, fungi and bacterial spores.

The term “highly effective or efficient,” when used in the context of a sporicidal liquid composition, refers to a composition that can kill spores according to EN 13704.

The term “stable” or “stability”, as used herein, refers to physical and/or chemical stability. Physical stability refers to retaining an original physical form without undergoing phase change or separation, discoloration, and the like. Chemical stability refers to resistance to impurity generation and degradation of active components.

As used herein, “storage stable” refers to a composition according to the invention, preferably in the form of a ready to use product, that shows no phase separation at about 40° C. for a period of at least 7 days, and preferably the composition shows no phase separation at about 40° C. for a period of at least 9 weeks.

As used herein, the term “ready to use” refers to a composition that can be directly applied to a surface to be disinfected without any further dilution.

As used herein, the term “surface” refers to a surface of a healthcare setting, a medical instrument, a healthcare setting, a tool, a machine, equipment, a structure, a building, or the like that is employed as part of a food processing, preparation, or storage activity. Examples of healthcare settings include hospitals, doctor's offices and long term care facilities. Examples of food processing surfaces include surfaces of food processing or preparation equipment, e.g., slicing, canning, or transport equipment, including flumes, of food processing wares, e.g., utensils, dishware, wash ware, and bar glasses), and of floors, walls, or fixtures of structures in which food processing occurs. Food processing surfaces are found and employed in milking machines, food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, auto dish sanitizers, sanitizing gels, cooling towers, food processing antimicrobial garment sprays, and non-to-low-aqueous food preparation lubricants, oils, and rinse additives.

As used herein, the term “ware” refers to items such as eating and cooking utensils, dishes, and other hard surfaces such as showers, sinks, toilets, bathtubs, countertops, windows, mirrors, transportation vehicles, and floors.

As used herein, the term “about” refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

It should be noted that, as used in this specification and the appended claims, the singular forms “a”, “an”, and “the” include plural referents unless the content clearly dictates otherwise. Thus, for example, reference to a composition containing “a compound” includes a composition having two or more compounds.

It should also be noted that the term “or” is generally employed in its sense including “and/or” unless the content clearly dictates otherwise.

As used herein, the phrases “objectionable odor”, “offensive odor”, or “malodor”, refer to a sharp, pungent, or acrid odor or atmospheric environment from which a typical person withdraws if they are able to. Hedonic tone provides a measure of the degree to which an odor is pleasant or unpleasant. An “objectionable odor”, “offensive odor”, or “malodor” has an hedonic tone rating it as unpleasant as or more unpleasant than a solution of >5 wt-% acetic acid, propionic acid, butyric acid, or mixtures thereof. However reducing the amount of acetic acid and peroxyacetic acid for example to ≤4 wt.-% improves and reducing the amount acetic acid and peroxyacetic acid to ≤3 wt.-%, preferably ≤2 wt.-%, improves significant the reduction of malodor.

The stable liquid, volatile peroxyacid containing sporicidal disinfecting composition disclosed herein may be effective for deactivating, inhibiting, disabling, killing, or otherwise sterilizing spores with ≥3 log reduction according to EN 13704.

It is specifically understood that any numerical value recited herein (e.g., ranges) includes all values from the lower value to the upper value, i.e., all possible combinations of numerical values between the lowest value and the highest value enumerated are to be considered to be expressly stated in this application. For example, if a concentration range is stated as 1 wt.-% to 50 wt.-%, it is intended that values such as 2 wt.-% to 40 wt.-%, 10 wt.-% to 30 wt.-%, or 1 wt.-% to 3 wt.-%, etc., are expressly enumerated in this specification. These are only examples of what is specifically intended.

Peroxy Alkanoic Acid with 2 to 8 Carbons

The stable liquid, volatile peroxyacid containing sporicidal disinfecting composition described herein include at least one C₂ to C₈ peroxyorganic acid. According to one aspect the stable liquid, volatile peroxyacid containing sporicidal disinfecting composition described herein may include at least one C₂ to C₃ peroxyorganic acid.

Examples of suitable C₂ to C₃ peroxycarboxylic acid include, but are not limited to peroxyacetic acid, peroxypropionic acid, as well as their branched isomers and mixtures thereof.

According to another aspect the stable liquid, volatile peroxyacid containing sporicidal disinfecting composition described herein may include a peroxyacetic acid.

However, in some embodiments peroxyacetic acid and/or peroxyoctanoic acid may be preferred and peroxyacetic acid as the sole peroxy acid may be most preferred.

The sporicidal liquid composition may comprise about ≥0.01 wt.-% to about ≤5 wt.-%, preferably ≥0.05 wt.-% to about ≤2 wt.-%, further preferred about ≥0.1 wt.-% to about ≤1 wt.-% and more preferred about ≥0.2 wt.-% to about ≤0.5 wt.-%, of a C₂ to C₈ peroxyorganic acid, preferably peroxyacetic acid, based on the total weight of the sporicidal liquid composition.

The sporicidal liquid composition may comprise about ≥0.01 wt.-% to about ≤5 wt.-%, preferably ≥0.05 wt.-% to about ≤2 wt.-%, further preferred about ≥0.1 wt.-% to about ≤1 wt.-% and more preferred about ≥0.2 wt.-% to about ≤0.5 wt.-%, of a C₂ to C₃ peroxyorganic acid, preferably peroxyacetic acid, based on the total weight of the sporicidal liquid composition.

C₂ to C₈ Organic Acid

The stable liquid sporicidal disinfecting composition according to the invention described herein include at least one C₂ to C₈ organic acid. According to one aspect the stable liquid, volatile, organic acid containing sporicidal disinfecting composition described herein may include at least one C₂ to C₃ organic acid.

Examples of suitable C₂ to C₃ carboxylic acids include, but are not limited to acetic acid, propionic acid, as well as their branched isomers and mixtures thereof.

According to another aspect the sporicidal disinfecting composition described herein may include an acetic acid.

However, in some embodiments acetic acid and/or octanoic acid may be preferred and acetic acid as the sole organic acid may be most preferred.

The stable liquid, volatile peroxyacid containing sporicidal disinfecting compositions may comprise about >0 wt.-% to about ≤10 wt.-% or ≥0.1 wt.-% to about ≤9 wt.-%, preferably of about ≥1 wt.-% to about ≤8 wt.-%, further preferred of about ≥2 wt.-% to about ≤6 wt.-%, and more preferred of about ≥3 wt.-% to about ≤4 wt.-%, of at least one C₂ to C₈ organic acid, preferably of at least one C₂ to C₃ organic acid and more preferred acetic acid, based on the total weight of the sporicidal liquid composition.

According to one aspect, the stable liquid, volatile peroxyacid containing sporicidal disinfecting compositions may comprise about ≥0.5 wt.-% to about ≤10 wt.-%, preferably about ≥1 wt.-% to about ≤8 wt.-%, further preferred about ≥2.5 wt.-% to about ≤5 wt.-% or about ≥3 wt.-% to about ≤4 wt.-%, of at least one C₂ to C₈ organic acid, preferably of at least one C₂ to C₃ organic acid and more preferred acetic acid, based on the total weight of the sporicidal liquid composition.

In a preferred embodiment, the stable liquid, volatile peroxyacid containing sporicidal disinfecting compositions do not contain phthalimidoalkanoic acids and/or their peroxyacids. Thus, e.g. Phthalimido-hexanoic peroxyacid should not be present.

### Alcohol

The sporicidal liquid compositions described herein include at least one C₂ to C₄ alcohol. The C₂ to C₄ alcohol can be selected from the group comprising ethanol, n-propanol, iso-propanol, butanol, isobutanol and tert-butanol, wherein ethanol and iso-propanol may be preferred and n-propanol may be most preferred.

The sporicidal liquid composition may comprises about ≥20 wt.-%, preferably about more than 20 wt.-% to about ≤50 wt.-%, or of about ≥25 wt.-% to about ≤45 wt.-%, or about >25 wt.-% to about ≤35 wt.-%, and in addition preferred of about ≥30 wt.-% to about ≤40 wt.-% C₂ to C₄ alcohol, wherein n-propanol is preferred, based on the total weight of the sporicidal liquid composition.

According to one aspect, the sporicidal liquid composition may comprises about ≥25 wt.-% to about ≤35 wt.-%, of a C₂ to C₄ alcohol, wherein n-propanol is preferred, based on the total weight of the sporicidal liquid composition.

### Builder/Sequestering Agents

The stable liquid, volatile peroxyacid containing sporicidal disinfecting compositions described herein may include organic phosphonic acids capable of sequestering bivalent metal cations. Preferred are low molecular weight aliphatic compounds containing at least two anion groups, at least one of which being a phosphonic acid group.

Sequestering agent (also called builder), can be selected from the group comprising phosphonic acid, and more preferred the builder is selected from the group comprising aminomethylphosphonic acid, dimethyl methyl phosphonate, 1-hydroxyethylidene-1,1-diphosphonic acid, amino tris(methylenephosphonic acid), ethylenediamine tetra(methylene phosphonic acid), tetramethylenediamine tetra (methylene phosphonic acid), hexamethylenediamine tetra(methylene phosphonic acid), diethylenetriamine penta(methylene phosphonic acid), phosphonobutane-tricarboxylic acid, N-(phosphonomethyl)iminodiacetic acid, 2-carboxyethyl phosphonic acid, 2-hydroxy phosphonocarboxylic acid, amino-tris-(methylene-phosphonic acid) and/or N,N-bis (phosphonomethyl)glycine. However 1-hydroxy ethylidene-1,1-diphosphonic acid (HEDP) can be most preferred.

Other preferred sequestering agents are aminocarboxylates and their derivatives, pyrophosphates, polyphosphates, ethylenediamene and ethylenetriamine derivatives, hydroxyacids, and mono-, di-, and tri-carboxylates and their corresponding acids.

According to one aspect, the sporicidal liquid composition may comprises about ≥0 wt.-% to about ≤5 wt.-%, preferably of about ≥0.1 wt.-% to about ≤3 wt.-%, further preferred of about ≥0.2 wt.-% to about ≤2 wt.-%, and in addition preferred of about ≥0.1 wt.-% to about ≤1.0 wt.-% or of about ≥0.3 wt.-% to about ≤1.0 wt.-% of a sequestering agent, based on the total weight of the sporicidal liquid composition.

However, the disinfecting composition can be free of a builder.

### Surfactants

The stable liquid, volatile peroxyacid containing sporicidal disinfecting compositions described herein can be free of surfactants, preferably free of anionic surfactants.

However, the stable liquid, volatile peroxyacid containing sporicidal disinfecting compositions described herein can comprise surfactants including anionic surfactants, amphoteric surfactants, cationic surfactants, zwitterionic surfactants, non-ionic surfactants, and/or combinations thereof, preferably about 0.1 wt.-% to about 10 wt.-%, based on the total weight of the sporicidal liquid composition.

In an embodiment of the invention, anionic surfactants might be present. Said anionic surfactants may be selected from the group comprising of alkylbenzene sulfonates having about 6 to about 18 carbon atoms in the alkyl, alkane sulfonates having about 8 to about 22 carbon atoms in the alkane, and alkyl sulfates having about 8 to about 22 carbons atoms in the alkyl.

In one embodiment, the sporicidal liquid composition comprises at least one amphoteric surfactant, preferably about 0.1 wt.-% to about 10 wt.-%, based on the sporicidal liquid composition.

Suitable amphoteric surfactants include, for example, betaines, alkylamido betaines, sulfobetaines, N-alkyl betaines, sultaines, amphoacetates, amophodiacetates, imidazoline carboxylates, sarcosinates, acylamphoglycinates, such as cocamphocarboxyglycinates and acylamphopropionates, and combinations thereof.

In a preferred embodiment, the stable liquid, volatile peroxyacid containing sporicidal disinfecting composition may comprise at least one surfactant in an amount of about ≥0.01 wt.-% to about ≤10 wt.-%, preferably of about ≥0.05 wt.-% to about ≤5 wt.-%, further preferred of about ≥0.1 wt.-% to about ≤2 wt.-%, and more preferred of about ≥0.25 wt.-% to about ≤1.5 wt.-%, wherein the surfactant is preferably an amphoteric surfactant, based on the total weight of the sporicidal liquid composition.

The stable liquid, volatile peroxyacid containing sporicidal disinfecting composition may include one surfactant or a combination of multiple surfactants of the same or different type as described above.

### Peroxide Agent

In some embodiments, the peroxide agent—also referred to active oxygen source herein—includes at least one peroxygen compound. Exemplary peroxygen compounds for use in the composition of the present invention include hydrogen peroxide, a perborate, a percarbonate and mixtures and derivatives thereof, and preferably hydrogen peroxide. In some embodiments, the active oxygen source includes hydrogen peroxide.

The stable liquid, volatile peroxyacid containing sporicidal disinfecting compositions may comprises a peroxide agent, preferably hydrogen peroxide, in an amount of about ≥2 wt.-% to about ≤20 wt.-%, preferably of about ≥3 wt.-% to about ≤15 wt.-%, further preferred of about ≥5 wt.-% to about ≤10 wt.-% or of about ≥5 wt.-% to about ≤15 wt.-%, and more preferred of about ≥4 wt.-% to about ≤9 wt.-% or about ≥7 wt.-% to about ≤9 wt.-%.

According to an embodiment, the sporicidal liquid compositions may comprise the hydrogen peroxide in an excess that means that the sporicidal liquid compositions may comprise about ≥5 wt.-% and ≤15 wt.-%, and more preferred about ≥7 wt.-% and ≤10 wt.-% hydrogen peroxide, based on the total weight of the sporicidal liquid composition.

It can be preferred that the peroxide agent, preferably hydrogen peroxide, has completely reacted with the C₂ to C₃ peroxyorganic acid, preferably acetic acid, to form the corresponding peroxy compounds. However, the hydrogen peroxide may be added in an excess that means that the sporicidal liquid compositions may comprise about ≥5 wt.-% and ≤15 wt.-%, preferably about ≥6 wt.-% and ≤10 wt.-% and more preferred about ≥7 wt.-% and ≤9 wt.-% hydrogen peroxide, based on the total weight of the sporicidal liquid composition.

### Solvent Water

Water is added at 100 wt.-% to the sporicidal liquid composition. That means that water can be added as the remaining component. The water can be tape water or preferably deionized water.

The balance of the sporicidal liquid composition can be water, or an aqueous medium. For example a mixed solvent system, buffer, etc., comprising water as the major component, so as to provide 100 wt.-% of a composition.

### Additives

The sporicidal liquid compositions may comprise a thickening agent, which may act to thicken or increase the viscosity of the composition. A thickener may be added to form a viscous liquid or gel. However, it is preferred that the sporicidal liquid compositions described herein is free of a thickening agent.

The composition may also include other additives such as stabilizers, fragrances, dyes, and the like.

Each additive, when present, may be added in amounts about ≥0 wt.-% to about ≤10 wt.-%, such as about ≥0.001 wt.-% to about ≤5% wt.-%, or about ≥0.01 wt.-% to about ≤1% wt.-%, based on the sporicidal liquid composition. However, it is preferred that the sporicidal liquid compositions described herein is free of additives, preferably free of fragrances, and/or dyes.

### Composition to Adjust the pH

The pH of the sporicidal liquid composition can be adjusted with acid or base, if necessary; wherein the acid or base used to adjust the pH differs from the other components of the sporicidal liquid composition.

Exemplary acids include citric acid, phosphoric acid, gluconic acid, lactic acid and glycolic acid. In some embodiments the acid is citric acid.

However, it can be preferred that the sporicidal liquid composition is free of an additional acid to adjust the pH. According to one embodiment the sporicidal liquid composition can be free of citric acid, phosphoric acid, gluconic acid, lactic acid and/or glycolic acid.

In some embodiments an alkylamine can be used to adjust the pH to be less acidic. Exemplary bases include sodium hydroxide, potassium hydroxide, and preferably alkylamines, further preferred ethanolamine and/or propanolamine, more preferred monoisopropanolamine, diisopropanolamine and/or triisopropanolamine, and most preferred triisopropanol and triethanolamine.

However, it can be preferred that the sporicidal liquid composition is free of an additional base to adjust the pH. According to one embodiment the sporicidal liquid composition can be free of hydroxide, potassium hydroxide, alkylamines, ethanolamine, propanolamine, monoisopropanolamine, diisopropanolamine, triisopropanolamine, triisopropanolamine and/or triethanolamine.

In some embodiments the sporicidal liquid composition may comprises about ≥0 wt.-% to about ≤5 wt.-%, preferably of about ≥0.05 wt.-% to about ≤1 wt.-%, further preferred of about ≥0.05 wt.-% to about ≤0.5 wt.-%, and more preferred of about ≥0.1 wt.-% to about ≤0.2 wt.-% or about 0.15 wt.-%, of an acid and/or base to adjust the pH, wherein the acid and/or base differs from the other components of the sporicidal liquid composition, preferably the base is selected from the group comprising alkylamine, further preferred ethanolamine and/or propanolamine, more preferred monoethanolamine, diethanolamine, n-monopropanolamine, n-dipropanolamine monoisopropanolamine, diisopropanolamine, triethanolamine, n-tripropanolamine and/or triisopropanolamine, and most preferred triethanolamine; based on the total weight of the composition.

The acid to adjust the pH can be an inorganic acid or an organic acid with at least 4 carbon atoms.

The pH of the stable liquid, volatile peroxyacid containing sporicidal disinfecting compositions can affect both stability of the formulation and the sporicidal activity. For example, lower pH may increase the sporicidal activity. In some embodiments, the sporicidal liquid compositions disclosed herein have a pH that is suitably selected to balance sporicidal efficacy.

In embodiments the sporicidal liquid composition has a pH in the range of about ≥1 pH to about ≤8 pH, preferably about ≥1.5 pH to about ≤7 pH, further preferred of about ≥2 pH to about ≤6 pH, more preferred of about ≥2.5 pH to about ≤5 pH, and most preferred of about ≥3 pH to about ≤4 pH.

In some embodiments the pH of the sporicidal liquid composition may be about ≥2.5 to about ≤4.5. Accordingly, the pH may be about ≥3.0 to about ≤4.5, about ≥4.0 to about ≤4.5, about ≥3.0 to about ≤4.0, about ≥3.5 to about ≤3.8, about ≥3.6 to about ≤3.7, about ≥3.5, about ≥3.6, about ≥3.7 or about ≥3.8. In embodiments, a composition may have a pH of up to about 2.5, up to about 3.0, up to about 3.5, up to about 3.6, up to about 3.7, up to about 3.8, up to about 3.9, up to about 4.0, up to about 4.5, at least about 2.5, at least about 3.0, at least about 3.5, at least about 3.6, at least about 3.7, at least about 3.8, at least about 3.9, or at least about 4.0.

However, according to one aspect the sporicidal liquid composition may be free of an additional acid or base to adjust the pH.

### Sporicidal Disinfecting Composition

In one embodiment the stable liquid, volatile peroxyacid containing sporicidal disinfecting composition may comprise:
about ≥0.01 wt.-% to about ≤5 wt.-%, preferably of about ≥0.05 wt.-% to about ≤2 wt.-%, preferably about ≥0.1 wt.-% to about ≤1 wt.-% or more preferred about ≥0.2 wt.-% to about ≤0.5 wt.-%, of peroxyacetic acid and/or peroxypropanoic acid, preferably peroxyacetic acid;
about ≥0 wt.-% to about ≤10 wt.-%, preferably about ≥1 wt.-% to about ≤8 wt.-%, further preferred about ≥2.5 wt.-% to about ≤5 wt.-% or about ≥3 wt.-% to about ≤4 wt.-%, of at least one C₂ to C₃ acid selected from the group comprising of acetic acid and/or propionic acid, and preferably the acid is acetic acid,
about ≥20 wt.-% to about ≤50 wt.-%, preferably of about ≥25 wt.-% to about ≤45 wt.-%, further preferred of about ≥27 wt.-% to about ≤37 wt.-%, and in addition preferred of about ≥30 wt.-% to about ≤35 wt.-% C₂ to C₄ alcohol, preferably ethanol, n-propanol and/or isopropanol or their mixtures, preferably n-propanol;
about ≥0 wt.-% to about ≤5 wt.-%, preferably of about ≥0.1 wt.-% to about ≤3 wt.-%, further preferred of about ≥0.2 wt.-% to about ≤2 wt.-%, and in addition preferred of about ≥0.3 wt.-% to about ≤1.0 wt.-%, of a sequestering agent, preferably phosphonic acid, and more preferred 1-hydroxy ethylidene-1,1-diphosphonic acid;
about ≥0 wt.-% to about ≤10 wt.-%, preferably of about ≥0.05 wt.-% to about ≤5 wt.-%, further preferred of about ≥0.1 wt.-% to about ≤2 wt.-%, and more preferred of about ≥0.25 wt.-% to about ≤1.5 wt.-%, of an amphoteric surfactant;
about ≥2 wt.-% to about ≤20 wt.-%, preferably of about ≥3 wt.-% to about ≤15 wt.-%, further preferred of about ≥5 wt.-% to about ≤10 wt.-%, and more preferred of about ≥4 wt.-% to about ≤9 wt.-% or about ≥7 wt.-% to about ≤9 wt.-% of hydrogen peroxide;
about ≥0 wt.-% to about ≤5 wt.-%, preferably of about ≥0.05 wt.-% to about ≤1 wt.-%, further preferred of about ≥0.05 wt.-% to about ≤0.5 wt.-%, and more preferred of about ≥0.1 wt.-% to about ≤0.2 wt.-% of an acid and/or base to adjust the pH, wherein the acid and/or base differs from the other components of the sporicidal liquid composition; preferably the base is selected from the group comprising of alkylamine, alkylamine, further preferred ethanolamine and/or propanolamine, more preferred monoethanolamine, diethanolamine, n-monopropanolamine, n-dipropanolamine monoisopropanolamine, diisopropanolamine, triethanolamine, n-tripropanolamine and/or triisopropanolamine, and most preferred triethanolamine;
add. water to 100 wt.-%; wherein the wt.-% are calculated on the total weight of the stable liquid, volatile peroxyacid containing sporicidal disinfecting composition.

In another embodiment the stable liquid, volatile peroxyacid containing sporicidal disinfecting composition may comprise:
about ≥0.01 wt.-% to about ≤5 wt.-%, preferably of about ≥0.05 wt.-% to about ≤2 wt.-%, preferably about ≥0.1 wt.-% to about ≤1 wt.-% or more preferred about ≥0.2 wt.-% to about ≤0.5 wt.-%, of peroxyacetic acid and/or peroxypropanoic acid, preferably peroxyacetic acid;
about ≥0.5 wt.-% to about ≤10 wt.-%, preferably of about ≥1 wt.-% to about ≤8 wt.-%, further preferred of about ≥2 wt.-% to about ≤6 wt.-%, and more preferred of about ≥3 wt.-% to about ≤4 wt.-%, of at least one C₂ to C₃ acid selected from the group comprising of acetic acid and/or propionic acid, and preferably the acid is acetic acid,
about ≥20 wt.-% to about ≤50 wt.-%, preferably of about ≥25 wt.-% to about ≤45 wt.-%, further preferred of about ≥27 wt.-% to about ≤37 wt.-%, and in addition preferred of about ≥30 wt.-% to about ≤35 wt.-% C₂ to C₄ alcohol, preferably ethanol, n-propanol and/or isopropanol or their mixtures, preferably n-propanol;
about ≥0 wt.-% to about ≤5 wt.-%, preferably of about ≥0.1 wt.-% to about ≤3 wt.-%, further preferred of about ≥0.2 wt.-% to about ≤2 wt.-%, and in addition preferred of about ≥0.3 wt.-% to about ≤1.0 wt.-%, of a sequestering agent, preferably phosphonic acid, and more preferred 1-hydroxy ethylidene-1,1-diphosphonic acid;
about ≥0 wt.-% to about ≤10 wt.-%, preferably of about ≥0.05 wt.-% to about ≤5 wt.-%, further preferred of about ≥0.1 wt.-% to about ≤2 wt.-%, and more preferred of about ≥0.25 wt.-% to about ≤1.5 wt.-%, of an amphoteric surfactant;
about ≥2 wt.-% to about ≤20 wt.-%, preferably of about ≥3 wt.-% to about ≤15 wt.-%, further preferred of about ≥5 wt.-% to about ≤10 wt.-%, and more preferred of about ≥4 wt.-% to about ≤9 wt.-% or about ≥7 wt.-% to about ≤9 wt.-% of hydrogen peroxide;
about ≥0 wt.-% to about ≤5 wt.-%, preferably of about ≥0.05 wt.-% to about ≤1 wt.-%, further preferred of about ≥0.05 wt.-% to about ≤0.5 wt.-%, and more preferred of about ≥0.1 wt.-% to about ≤0.2 wt.-% of an acid and/or base to adjust the pH, wherein the acid and/or base differs from the other components of the sporicidal liquid composition, preferably the base is selected from the group comprising alkylamine, further preferred ethanolamine and/or propanolamine, more preferred monoethanolamine, diethanolamine, n-monopropanolamine, n-dipropanolamine monoisopropanolamine, diisopropanolamine, triethanolamine, n-tripropanolamine and/or triisopropanolamine, and most preferred triethanolamine;
add. water to 100 wt.-%; wherein the wt.-% are calculated on the total weight of the stable liquid, volatile peroxyacid containing sporicidal disinfecting composition; wherein the stable liquid, volatile peroxyacid containing sporicidal disinfecting composition has a pH in the range of about ≥2.5 pH to about ≤5 pH, and most preferred of about ≥2.5 pH to about ≤4 pH.

In another embodiment the stable liquid, volatile peroxyacid containing sporicidal disinfecting composition may comprise:
about ≥0.1 wt.-% to about ≤1 wt.-% or preferably about ≥0.2 wt.-% to about ≤0.5 wt.-%, of peroxyacetic acid and/or peroxypropanoic acid, preferably peroxyacetic acid;
about ≥2 wt.-% to about ≤6 wt.-% or about ≥3 wt.-% to about ≤4 wt.-%, of at least one C₂ to C₃ acid selected from the group comprising of acetic acid and/or propionic acid, and preferably the acid is acetic acid,
about ≥25 wt.-% to about ≤45 wt.-%, and in addition preferred of about ≥30 wt.-% to about ≤35 wt.-% C₂ to C₄ alcohol, preferably n-propanol;
about ≥0 wt.-% to about ≤2 wt.-%, and in addition preferred of about ≥0.2 wt.-% to about ≤1.0 wt.-%, of a sequestering agent, preferably phosphonic acid, and more preferred 1-hydroxy ethylidene-1,1-diphosphonic acid;
about ≥0 wt.-% to about ≤2 wt.-%, and more preferred of about ≥0.25 wt.-% to about ≤1.5 wt.-%, of an amphoteric surfactant;
about ≥4 wt.-% to about ≤10 wt.-% or about ≥7 wt.-% to about ≤9 wt.-% of hydrogen peroxide;
about ≥0 wt.-% to about ≤0.5 wt.-%, and more preferred of about ≥0.1 wt.-% to about ≤0.2 wt.-%, of an acid and/or base to adjust the pH, wherein the acid and/or base differs from the other components of the sporicidal liquid composition, preferably the base is selected from the group comprising alkylamine, further preferred ethanolamine and/or propanolamine, more preferred monoethanolamine, diethanolamine, n-monopropanolamine, n-dipropanolamine monoisopropanolamine, diisopropanolamine, triethanolamine, n-tripropanolamine and/or triisopropanolamine, and most preferred triethanolamine;
add. water to 100 wt.-%; wherein the wt.-% are calculated on the total weight of the stable liquid, volatile peroxyacid containing sporicidal disinfecting composition.

In another embodiment the stable liquid, volatile peroxyacid containing sporicidal disinfecting composition may comprise:
about ≥0.2 wt.-% to about ≤0.5 wt.-%, of peroxyacetic acid and/or peroxypropanoic acid, preferably peroxyacetic acid;
about ≥2.5 wt.-% to about ≤5 wt.-% or about ≥3 wt.-% to about ≤4 wt.-% of a C₂ to C₃ acid selected from the group comprising of acetic acid and/or propionic acid, and preferably the acid is acetic acid,
about ≥25 wt.-% to about ≤35 wt.-%, of at least one C₂ to C₄ alcohol, preferably n-propanol;
about ≥0 wt.-% to about ≤2 wt.-%, and in addition preferred of about ≥0.2 wt.-% to about ≤1.0 wt.-%, of a sequestering agent, preferably phosphonic acid, and more preferred 1-hydroxy ethylidene-1,1-diphosphonic acid;
about ≥0 wt.-% to about ≤2 wt.-%, and more preferred of about ≥0.25 wt.-% to about ≤1.5 wt.-%, of an amphoteric surfactant;
about ≥7 wt.-% to about ≤9 wt.-% of hydrogen peroxide;
about ≥0 wt.-% to about ≤0.5 wt.-%, and more preferred of about ≥0.1 wt.-% to about ≤0.2 wt.-% of an acid and/or base to adjust the pH, wherein the acid and/or base differs from the other components of the sporicidal liquid composition, preferably the base is selected from the group comprising alkylamine, further preferred ethanolamine and/or propanolamine, more preferred monoethanolamine, diethanolamine, n-monopropanolamine, n-dipropanolamine monoisopropanolamine, diisopropanolamine, triethanolamine, n-tripropanolamine and/or triisopropanolamine, and most preferred triethanolamine;
add. water to 100 wt.-%; wherein the wt.-% are calculated on the total weight of the stable liquid, volatile peroxyacid containing sporicidal disinfecting composition.

In another embodiment the stable liquid, volatile peroxyacid containing sporicidal disinfecting composition may comprise:
about ≥0.2 wt.-% to about ≤0.5 wt.-%, of peroxyacetic acid and/or peroxypropanoic acid, preferably peroxyacetic acid;
about ≥3 wt.-% to about ≤4 wt.-% of acetic acid,
about ≥25 wt.-% to about ≤35 wt.-%, at least one C₂ to C₄ alcohol, preferably n-propanol;
about ≥0.2 wt.-% to about ≤1.0 wt.-%, of a sequestering agent, preferably phosphonic acid, and more preferred 1-hydroxy ethylidene-1,1-diphosphonic acid;
about ≥0.25 wt.-% to about ≤1.5 wt.-%, of an amphoteric surfactant;
about ≥7 wt.-% to about ≤9 wt.-% of hydrogen peroxide;
about ≥0 wt.-% to about ≤0.5 wt.-%, and more preferred of about ≥0.1 wt.-% to about ≤0.2 wt.-% of an acid and/or base to adjust the pH, wherein the acid and/or base differs from the other components of the sporicidal liquid composition, preferably the base is selected from the group comprising alkylamine, further preferred ethanolamine and/or propanolamine, more preferred monoethanolamine, diethanolamine, n-monopropanolamine, n-dipropanolamine monoisopropanolamine, diisopropanolamine, triethanolamine, n-tripropanolamine and/or triisopropanolamine, and most preferred triethanolamine;
add. water to 100 wt.-%; wherein the wt.-% are calculated on the total weight of the stable liquid, volatile peroxyacid containing sporicidal disinfecting composition.

In another embodiment the stable liquid, volatile peroxyacid containing sporicidal disinfecting composition may comprise:
about ≥0.2 wt.-% to about ≤0.5 wt.-%, of peroxyacetic acid and/or peroxypropanoic acid, preferably peroxyacetic acid;
about ≥2.5 wt.-% to about ≤5 wt.-% or about ≥3 wt.-% to about ≤4 wt.-% of acetic acid,
about ≥25 wt.-% to about ≤35 wt.-% C₂ to C₄ alcohol, preferably n-propanol;
about ≥0 wt.-% to about ≤2 wt.-%, and in addition preferred of about ≥0.2 wt.-% to about ≤1.0 wt.-%, of a sequestering agent, preferably phosphonic acid, and more preferred 1-hydroxy ethylidene-1,1-diphosphonic acid;
about ≥0 wt.-% to about ≤2 wt.-%, and more preferred of about ≥0.25 wt.-% to about ≤1.5 wt.-%, of an amphoteric surfactant;
about ≥7 wt.-% to about ≤9 wt.-% of hydrogen peroxide;
about ≥0 wt.-% to about ≤0.5 wt.-%, and more preferred of about ≥0.1 wt.-% to about ≤0.2 wt.-% of an acid and/or base to adjust the pH, wherein the acid and/or base differs from the other components of the sporicidal liquid composition, preferably the base is selected from the group comprising alkylamine, further preferred ethanolamine and/or propanolamine, more preferred monoethanolamine, diethanolamine, n-monopropanolamine, n-dipropanolamine monoisopropanolamine, diisopropanolamine, triethanolamine, n-tripropanolamine and/or triisopropanolamine, and most preferred triethanolamine;
add. water to 100 wt.-%; wherein the wt.-% are calculated on the total weight of the stable liquid, volatile peroxyacid containing sporicidal disinfecting composition; wherein the stable liquid, volatile peroxyacid containing sporicidal disinfecting composition has a pH in the range of about ≥2.5 pH to about ≤5 pH, and most preferred of about ≥2.5 pH to about ≤4 pH.

In a preferred embodiment, the composition has a pH in the range of about ≥1 pH to about ≤8 pH, preferably about ≥1.5 pH to about ≤7 pH, further preferred of about ≥2 pH to about ≤6 pH, more preferred of about ≥2.5 pH to about ≤5 pH, and most preferred of about ≥2.5 pH to about ≤4 pH.

### Use of the Sporicidal Liquid Composition

The sporicidal liquid composition maybe used for disinfection, preferably for deactivating, inhibiting, disabling, killing, and/or sterilizing bacterial spores.

The sporicidal liquid composition maybe used for example for deactivating, inhibiting, disabling, killing and/or sterilizing spores from surgical, medical, and dental instruments, including endoscopes and any kind of equipment or building surface in healthcare settings, like hospitals, doctor's offices and long-term care facilities.

### Method of Preparation

The sporicidal liquid compositions may be generally prepared by any appropriate manufacturing processes and using any appropriate manufacturing equipment such as are known in the art. In an exemplary process, the various formulation components are sequentially added to water, with stirring between each addition to ensure dissolution and/or dispersion of the previous component. For example, a formulation may be prepared by first adding hydrogen peroxide to water with stirring. This may be followed by addition of one or more of the other components sequentially or simultaneously.

In embodiments, the compositions may be prepared at ambient temperature.

A method of manufacture of the sporicidal liquid composition include, adding the components in an amount according to the invention comprising:
hydrogen peroxide,
at least one C₂ to C₄ alcohol,
C₂ to C₈ organic acid, preferably C₂ to C₃ organic acid, more preferred acetic acid, and
water.

Another method of manufacture of the sporicidal liquid composition include, adding the components in an amount according to the invention comprising:
hydrogen peroxide,
at least one C₂ to C₄ alcohol,
C₂ to C₃ organic acid, more preferred acetic acid, and
water.

According to one aspect the method of manufacture of the sporicidal liquid composition include, adding the components in an amount comprising:
about ≥2 wt.-% to about ≤20 wt.-% hydrogen peroxide,
about ≥0.05 wt.-% to about ≤10 wt.-% acetic acid and/or propionic acid,
about ≥20 wt.-% to about ≤50 wt.-%, preferably >20 wt.-%, of at least one C₂ to C₄ alcohol, preferably at least one C₂ to C₃ alcohol and more preferred n-propanol or iso-propanol, and most preferred n-propanol,
optional surfactant and sequestering agent,
the remainder to 100% by weight is water.

According to one aspect the method of manufacture of the sporicidal liquid composition include, adding the components in an amount comprising:
about ≥2 wt.-% to about ≤10 wt.-% hydrogen peroxide;
about ≥0.05 wt.-% to about ≤10 wt.-% acetic acid and/or propionic acid;
about ≥20 wt.-% to about ≤50 wt.-%; preferably >20 wt.-%; of at least one C₂ to C₄ alcohol; preferably at least one C₂ to C₃ alcohol and more preferred n-propanol or iso-propanol; and most preferred n-propanol;
optional a sequestering agent;
the remainder to 100% by weight is water.

### Determination of Sporicidal Efficacy

The following example was carried out to illustrate the sporicidal efficacy of the disinfectant according to the invention.

The sporicidal efficacy of the examples was investigated against a spore suspension of Bacillus subtilis spores (DSM 347). The investigations were performed according to the procedure of the quantitative suspension test according to European norm DIN EN 13704 (2002). The chosen neutralisation method was in each case the membrane filtration method according to EN 13704. The test concentration was 80%, which is the maximum possible test concentration in this test, i.e. the test samples were used undiluted in the test. The contact time was 2, 5, 15, 30 and 60 minutes (E1 to E5 and C1) and the test temperature was room temperature of 20° C. The tests were performed with an interfering substance of 0.3 g/l bovine albumin (simulated clean conditions following EN 13704). The incubation temperature of all cultures was 30° C.

The non-toxicity of the chosen neutraliser solution and the sufficient neutralisation of the test substance by the neutralisation process were proven beforehand. It was proven as well the selected experimental conditions had no adverse effect on the test organisms.

Based upon the provisions of the European norm DIN 13704 (2002), sporicidal efficacy for a disinfectant is shown by demonstrating a reduction of the spores within a contact time of 60 minutes by a factor of 10³ (3 log).

Table 1 shows the components used and the initial concentrations of the starting substances for preparing the compositions. The compositions were prepared by adding the components to water and mixing at room temperature. The samples E1 to E5 are examples according to the invention and the sample C1 is a comparative examples.

TABLE 1
Compositions according to the invention E1 to E5
and reference compositions C1 for comparison:

| Components | E 1 | E 2 | E 3 | E4 | E5 | |
|---|---|---|---|---|---|---|
| [wt.-%] | (PAA38) | (PAA41) | (PAA56) | (PAA61) | (PAA52) | C1 |
| n-Propanol | 30 | 30 | | | 30 | 60 |
| iso-Propanol | | | 30 | 30 | | |
| H₂O₂ | 9 | 9 | 7.5 | 5.75 | 7.5 | 6 |
| Phthalimido-hexanoic acid | — | — | — | — | — | 0.5 |
| Acetic acid | 3.84 | 3.84 | 3.84 | 3.84 | 3.84 | — |
| 1-Hydroxy-ethylidene-1,1,- | 0.06 | 0.06 | 0.30 | 0.06 | 0.06 | 0.4 |
| diphosphonic acid | | | | | | |
| Triethanolamine | 0.15 | 0.8 | 0.15 | 0.15 | 0.09 | — |
| water, deionized [wt.-%] | ad 100 | ad 100 | ad 100 | ad 100 | ad 100 | ad 100 |
| pH | 3.0 | 3.1 | 3.0 | 3.1 | 3 | 2 |

The components of table 1 are mixed, whereby due to H₂O₂ the peroxy compounds phthalimido-perhexanoic acid and peracetic acid are synthesized in situ.

The following table 2 shows the results of the examples of table 1 for a contact time of 2, 5, 15, 30 and 60 minutes at room temperature 20° C. with an interfering substance of 0.3 g/l bovine albumin.

TABLE 2
Reduction of spores:

| contact time/ | | | | | | |
|---|---|---|---|---|---|---|
| log reduction | E 1 | E 2 | E 3 | E4 | E5 | C1 |
| 2 min. | 2.02 | 2.63 | >3.1 | 2.14 | 2.4 | — |
| 5 min. | >3.0 | >3.0 | >3.1 | >3.3 | >3.6 | — |
| 15 min. | >3.0 | >3.0 | >3.1 | >3.3 | <3.6 | 1.26 |
| 30 min. | >3.0 | >3.0 | >3.1 | >3.3 | >3.6 | 3.2 |
| 60 min. | >3.0 | >3.0 | >3.1 | >3.3 | >3.6 | 3.25 |

It can be seen in table 2 that for the samples E1 to E5 according to the invention the required spore reduction of at least 1×10³ could be demonstrated at about 5 minutes of contact time, whereas the respective reference C1 did not show sufficient reduction in spores. Further, the samples E1 to E5 according to the invention provides a spore reduction of at least 1×10² at about 2 minutes contact time, whereas the respective reference C1 to C6 did not show significant reduction in spores at about 2 minutes. This shows that the formulations according to the invention had adequate sporicidal efficacy against Bacillus subtilis in the quantitative suspension test according to European norm DIN EN 13704 (2002) at a contact time of 5 min, when tested undiluted.

Furthermore, the Examples according to the invention showed despite the relatively high amount of alcohols excellent storage stability.

Embodiments of the present invention have been disclosed above for illustrative purposes. Those skilled in the art will appreciate that various modifications, additions and substitutions are possible, without departing from the scope and spirit of the invention as disclosed in the accompanying claims. In the embodiments of the present invention, the stable liquid, volatile peroxyacid containing sporicidal disinfecting composition has been taken as an example for description. However, this is only an example, and the stable liquid, volatile peroxyacid containing sporicidal disinfecting composition in accordance with embodiments of the present invention may be applied to other products. The scope of the invention should be limited only by the accompanying claims.

1. A stable liquid, volatile peroxyacid containing sporicidal disinfecting composition comprising
about ≥0.05 wt.-% to about ≤10 wt.-% of at least one C₂ to C₈ carboxylic acid and at least one C₂ to C₈ peroxycarboxylic acid,
about ≥2 wt.-% to about ≤20 wt.-% of an peroxide agent,
about ≥20 wt.-% to about ≤50 wt.-% of an alcohol with about 2 to about 4 carbons,
the remainder to 100% by weight is water, based on the total weight of the sporicidal liquid composition.

2. The stable liquid, volatile peroxyacid containing sporicidal disinfecting composition of claim 1, wherein the peroxyacid is present in an amount of about ≥0.01 wt.-% to about ≤5 wt.-%, wherein the weight-% is based on the total weight of the sporicidal liquid composition.

3. The stable liquid, volatile peroxyacid containing sporicidal disinfecting composition of claim 1, wherein the alcohol is a C₂ to C₄ alcohol is selected from the group consisting of ethanol, n-propanol, iso-propanol, butanol, isobutanol and tert-butanol.

4. The stable liquid, volatile peroxyacid containing sporicidal disinfecting composition according to claim 1, wherein the composition comprises about ≥20 wt.-% to about ≤50 wt.-%, based on the total weight of the sporicidal liquid composition.

5. The stable liquid, volatile peroxyacid containing sporicidal disinfecting composition according to claim 1, wherein the composition comprises about >0 wt.-% to about ≤10 wt. % of at least one C₂ to C₈ organic acid based on the total weight of the sporicidal liquid composition

6. The stable liquid, volatile peroxyacid containing sporicidal disinfecting composition according to claim 1, wherein the composition comprises about ≥2 wt.-% to about ≤20 wt. % of an peroxide agent, wherein the weight-% is based on the total weight of the sporicidal liquid composition.

7. The stable liquid, volatile peroxyacid containing sporicidal disinfecting composition according to claim 1, wherein additionally a sequestering compound is present in an amount of about ≥0 wt.-% to about ≤5 wt.-%, wherein the weight-% is based on the total weight of the sporicidal liquid composition.

8. The stable liquid, volatile peroxyacid containing sporicidal disinfecting composition according to claim 1, wherein additionally one or more surfactant is present in an amount of about ≥0.01 wt.-% to about ≤10 wt.-%, wherein the weight-% is based on the total weight of the sporicidal liquid composition.

9. The stable liquid, volatile peroxyacid containing sporicidal disinfecting composition according to claim 1, wherein the surfactants are selected from the group consisting of amphoteric surfactants, cationic surfactants, zwitterionic surfactants, nonionic surfactants, anionic surfactants and/or combinations thereof.

10. The stable liquid, volatile peroxyacid containing sporicidal disinfecting composition according to claim 1, wherein the surfactant is an amphoteric surfactant and the amphoteric surfactant is present in an amount of about ≥0.01 wt.-% to about ≤10 wt.-%, wherein the weight-% is based on the total weight of the sporicidal liquid composition.

11. The sporicidal liquid composition of claim 1, wherein the composition comprises about ≥0 wt.-% to about ≤5 wt. % of at least one builder selected from the group consisting of phosphonic acid, aminomethylphosphonic acid, dimethyl methyl phosphonate, 1-hydroxyethylidene-1,1-diphosphonic acid, amino tris(methylenephosphonic acid), ethylenediamine tetra(methylene phosphonic acid), tetramethylenediamine tetra (methylene phosphonic acid), hexamethylenediamine tetra(methylene phosphonic acid), diethylenetriamine penta(methylene phosphonic acid), phosphonobutane-tricarboxylic acid, N-(phosphonomethyl)iminodiacetic acid, 2-carboxyethyl phosphonic acid, 2-hydroxy phosphonocarboxylic acid, amino-tris-(methylene-phosphonic acid), and N,N-bis (phosphonomethyl)glycine, based on the total weight of the sporicidal liquid composition.

12. The stable liquid, volatile peroxyacid containing sporicidal disinfecting composition according to claim 1, wherein the composition comprises about ≥0 wt.-% to about ≤5 wt. % of an acid and/or base to adjust the pH, wherein the acid and/or base differs from the other components of the sporicidal liquid composition, and is selected from the group consisting of alkylamine, ethanolamine, propanolamine, monoethanolamine, diethanolamine, n-monopropanolamine, n-dipropanolamine monoisopropanolamine, diisopropanolamine, triethanolamine, n-tripropanolamine, and triisopropanolamine, based on the total weight of the composition.

13. The sporicidal liquid composition of claim 1, wherein the sporicidal liquid composition has a pH in the range of about ≥1 pH to about ≤8 pH.

14. The stable liquid, volatile peroxyacid containing sporicidal disinfecting composition according to claim 1, wherein the stable liquid, volatile peroxyacid containing sporicidal disinfecting composition may comprise:
about ≥0.01 wt.-% to about ≤5 wt. % of peroxyacetic acid or peroxypropanoic acid;
about ≥0 wt.-% to about ≤10 wt. % of at least one C₂ to C₃ acid selected from the group comprising of acetic acid or propionic acid,
about ≥20 wt.-% to about ≤50 wt. % of a C₂ to C₄ alcohol selected from the group consisting of ethanol, n-propanol, isopropanol and mixtures thereof;
about ≥0 wt.-% to about ≤5 wt. % of a sequestering agent;
about ≥0 wt.-% to about ≤10 wt. % of an amphoteric surfactant;
about ≥2 wt.-% to about ≤20 wt. % of hydrogen peroxide;
about ≥0 wt.-% to about ≤5 wt. % of an acid and/or base to adjust the pH, wherein the acid and/or base differs from the other components of the sporicidal liquid composition selected from the group consisting of alkylamine, alkylamine, ethanolamine, propanolamine, monoethanolamine, diethanolamine, n-monopropanolamine, n-dipropanolamine monoisopropanolamine, diisopropanolamine, triethanolamine, n-tripropanolamine, and triisopropanolamine;
add. water to 100 wt.-%; wherein the wt.-% are calculated on the total weight of the stable liquid, volatile peroxyacid containing sporicidal disinfecting composition.

15. The method of manufacture of the stable liquid, volatile peroxyacid containing sporicidal disinfecting composition according to claim 1, wherein the sporicidal liquid composition is obtained by adding the components comprising:
peroxide agent,
at least one C₂ to C₄ alcohol,
C₂ to C₈ organic acid, and
water.

16. Use of the stable liquid, volatile peroxyacid containing sporicidal disinfecting composition according to directly or diluted with water for disinfection, for deactivating, inhibiting, disabling, killing, and/or sterilizing bacterial spores.
